(19) United States
(12) Patent Application Publication
(10) Pub. No.: US 2008/0144225 A1
(43) Pub. Date: Jun. 19, 2008

(54) Techniques for reducing flexure distortion and gimbal separation for thin-film PZT micro-actuators of head gimbal assemblies

(75) Inventors: MingGao Yao, Dongguan (CN); YiRu Xie, Dongguan (CN); FengAn Huang, Dongguan (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K.) Ltd., Hong Kong (CN)

(21) Appl. No.: 11/638,565

(22) Filed: Dec. 14, 2006

(51) Int. Cl. G11B 5/48; G11B 5/56

(52) U.S. Cl. 360/294.4; 360/245.4

(57) ABSTRACT

Systems and methods for reducing flexure distortion and/or gimbal separation for thin-film piezoelectric transducer (PZT) micro-actuators for head gimbal assemblies (HGA) of disk drive devices are provided. In certain example embodiments, a head gimbal assembly may comprise a suspension including a suspension flexure. The suspension flexure may include a micro-actuator mounting region. A micro-actuator may be mounted to the micro-actuator mounting region of the suspension flexure. At least one support may be formed on the micro-actuator mounting region, such that the support increases the stiffness of the suspension flexure. The supports may be a single bar-shape, two separated bar-shapes, circle-shaped, rectangle-shaped, cross-shaped, etc. The supports may be made of metal, and they may be formed by chemical etching.

### FIELD OF THE INVENTION

The example embodiments herein relate to information recording disk drive devices and, more particularly, to manufacturing techniques that reduce flexure distortion and/or gimbal separation for thin-film piezoelectric transducer (PZT) micro-actuators for head gimbal assemblies (HGA) of disk drive devices.

### BACKGROUND OF THE INVENTION

One known type of information storage device is a disk drive device that uses magnetic media to store data and a movable read/write head 103 that is positioned over the media to selectively read from or write to the disk.

Consumers are constantly desiring greater storage capacity for such disk drive devices, as well as faster and more accurate reading and writing operations. Thus, disk drive manufacturers have continued to develop higher capacity disk drives by, for example, increasing the density of the information tracks on the disks by using a narrower track width and/or a narrower track pitch. However, each increase in track density requires that the disk drive device have a corresponding increase in the positional control of the read/write head in order to enable quick and accurate reading and writing operations using the higher density disks. As track density increases, it becomes more and more difficult using known technology to quickly and accurately position the read/write head over the desired information tracks on the storage media. Thus, disk drive manufacturers are constantly seeking ways to improve the positional control of the read/write head in order to take advantage of the continual increases in track density.

One approach that has been effectively used by disk drive manufacturers to improve the positional control of read/write heads for higher density disks is to employ a secondary actuator, known as a micro-actuator, that works in conjunction with a primary actuator to enable quick and accurate positional control for the read/write head. Disk drives that incorporate micro-actuators are known as dual-stage actuator systems.

Various dual-stage actuator systems have been developed in the past for the purpose of increasing the access speed and fine tuning the position of the read/write head over the desired tracks on high density storage media. Such dual-stage actuator systems typically include a primary voice-coil motor (VCM) actuator and a secondary micro-actuator, such as a PZT element micro-actuator. The VCM actuator is controlled by a servo control system that rotates the actuator arm that supports the read/write head to position the read/write head over the desired information track on the storage media. The PZT element micro-actuator is used in conjunction with the VCM actuator for the purpose of increasing the positioning access speed and fine tuning the exact position of the read/write head over the desired track. Thus, the VCM actuator makes larger adjustments to the position of the read/write head, while the PZT element micro-actuator makes smaller adjustments that fine tune the position of the read/write head relative to the storage media. In conjunction, the VCM actuator and the PZT element micro-actuator enable information to be efficiently and accurately written to and read from high density storage media.

One known type of micro-actuator incorporates PZT elements for causing fine positional adjustments of the read/write head. Such PZT micro-actuators include associated electronics that are operable to excite the PZT elements on the micro-actuator to selectively cause expansion or contraction thereof. The PZT micro-actuator is configured such that expansion or contraction of the PZT elements causes movement of the micro-actuator which, in turn, causes movement of the read/write head. This movement is used to make faster and finer adjustments to the position of the read/write head, as compared to a disk drive unit that uses only a VCM actuator. Exemplary PZT micro-actuators are disclosed in, for example, JP 2002-133803; U.S. Pat. Nos. 6,671,131 and 6,700,749; and U.S. Publication No. 2003/0168935, the contents of each of which are incorporated herein by reference.

FIGS. 1 and 2 illustrate a conventional disk drive unit and show a magnetic disk 101 mounted on a spindle motor 102 for spinning the disk 101. A voice coil motor arm 104 carries a head gimbal assembly (HGA) 100 that includes a micro-actuator 105 with a slider incorporating a read/write head 103. A voice-coil motor (VCM) is provided for controlling the motion of the motor arm 104 and, in turn, controlling the slider to move from track to track across the surface of the disk 101, thereby enabling the read/write head 103 to read data from or write data to the disk 101.

Because of the inherent tolerances (e.g. dynamic play) of the VCM and the head suspension assembly, the slider cannot achieve quick and fine position control which adversely impacts the ability of the read/write head 103 to accurately read data from and write data to the disk when only a servo motor system is used. As a result, a PZT micro-actuator 105, as described above, is provided in order to improve the positional control of the slider and the read/write head 103. More particularly, the PZT micro-actuator 105 corrects the displacement of the slider on a much smaller scale, as compared to the VCM, in order to compensate for the resonance tolerance of the VCM and/or head suspension assembly. The micro-actuator 105 enables, for example, the use of a smaller recording track pitch, and can increase the “tracks-per-inch” (TPI) value for the disk drive unit, as well as provide an advantageous reduction in the head seeking and settling time. Thus, the PZT micro-actuator 105 enables the disk drive device to have a significant increase in the surface recording density of the information storage disks used therein.

FIGS. 3 and 4 illustrate the head gimbal assembly (HGA) 100 incorporating a dual-stage actuator in the conventional disk drive device of FIGS. 1 and 2. More particularly, FIG. 3 is an enlarged perspective view of a conventional HGA of the disk drive from FIGS. 1 and 2. FIG. 4 is a top view of the HGA of FIG. 3. A slider having a read/write head 103 formed thereon is partially mounted on the slider support 121 of the suspension. A bump 127 is formed on the slider support 121 to support the center of the slider's back surface. A flex cable 122 with a plurality of traces couples the slider support 121 and a metal base flexure 123.

A suspension load beam 124 with a dimple 125 supports the slider support 121 and flexure 123. The dimple 125 of the suspension load beam supports the bump 127 of the slider support. This ensures that the load force from the load beam 124 is applied to the slider center when the head is flying over the disk. There are two thin-film PZT pieces comprising thin-film PZT micro-actuator 10, which are attached on the tongue region 128 near the flex cable 122 of the suspension and at least partially under the read/write head 104 and/or slider.

When a voltage is input to the thin-film PZT pieces, one of the two PZT pieces may contract, and the other one may expand. Unfortunately, expansions and/or contractions may generate a rotation torque relative to the slider support 121. For example, the slider support 121 and the slider may rotate against the dimple 125 of the suspension load beam because the slider support 121 and the flexure 123 are coupled to tongue region 128 by the flex cable. The thickness of the tongue region 128 typically is only 10-20 μm, and the tongue region 128 typically is formed from a flexible polymer. Thus, this soft material may be damaged by the generated torque. It also is easily deformed during the manufacturing and handling process. The resulting deformations may, for example, cause dimple separation and have serious, disadvantageous effects on HGA performance.

Another disadvantage of the conventional design of the conventional head gimbal assemblies described in relation to FIGS. 3 and 4 relates to shock performance. As noted above, the slider is partially mounted on the slider support 121, and the slider support 121 is coupled to the flexure base by a flex cable. The flex cable typically also is formed from a soft polymer material. As a result, the shock performance of the full structure may be very poor. For example, vibration and/or shock events may cause the suspension and/or the thin film PZT pieces to become damaged (e.g. cracked, broken, etc.).

FIGS. 5 and 6 illustrate the these deformation and separation problems associated with conventional head gimbal assemblies graphically and in more detail. For example, FIG. 5 shows a suspension tongue region deformation problem associated with a conventional HGA. As noted above, the slider support 121 is coupled to the flexure 123 by a flex cable 122 in its tongue region 128. The flex cable is formed from a soft polymer material, and it is 10-20 μm thick. Thus, the suspension is easily deformed at the tongue region 128. Deformations may occur, for example, when the suspension is manufactured or ultrasonically cleaned, or when the HGA is manufactured. Additionally, deformations also may occur as a result of shocks, vibration, or the like, because the structure as a whole tends to be weak.

FIG. 6 shows a dimple separation problem associated with a conventional HGA. As noted above, suspension load beam 124 with a dimple 125 conventionally is designed to support the slider support 121 and flexure 123 by linking with the bump 127 of the slider support. However, as a result of, for example, the suspension and/or HGA manufacturing processes, shocks, vibrations, or the like, the dimple 125 and the bump 127 may become separated.

Thus, it will be appreciated that there is a need in the art for an improved system that does not suffer from one or more of the above-mentioned drawbacks.

### SUMMARY OF THE INVENTION

One aspect of the present invention relates to a head gimbal assembly. Certain example embodiments may comprise a suspension including a suspension flexure. The suspension flexure may include a micro-actuator mounting region located in the suspension flexure. A micro-actuator may be mounted to the micro-actuator mounting region of the suspension flexure. At least one support may be formed on the micro-actuator mounting region, such that the support increases the stiffness of the suspension flexure.

Another aspect of the present invention relates to a disk drive device. Certain example embodiments may comprise a head gimbal assembly. A drive arm may be connected to the head gimbal assembly. A spindle motor may be operable to spin a disk. The head gimbal assembly may comprise a suspension including a suspension flexure. The suspension flexure may include a micro-actuator mounting region located in the suspension flexure. A micro-actuator may be mounted to the micro-actuator mounting region of the suspension flexure. At least one support may be formed on the micro-actuator mounting region, such that the support increases the stiffness of the suspension flexure.

Yet another aspect of the present invention relates to a method for manufacturing a head gimbal assembly. Certain example embodiments may comprise forming a slider support. PZT elements may be attached to the slider support. A flexure of a suspension may be prepared. The flexure and the slider support may be connected. A base plate, load beam, and hinge of the suspension may be formed. The suspension may be assembled by mounting the base plate, load beam, hinge, and flexure to one another. At least one support proximate to the PZT elements may be formed, and the support may be capable of increasing the stiffness of the flexure.

According to certain example embodiments, the support may be made of metal, and it may be formed by chemical etching. The PZT mounting region may divided into two halves, with each half having an outside edge. One or more supports may be located on each half of the PZT mounting region. Each supports may be shaped and located as follows: a single bar-shaped support located parallel to the base of the PZT mounting region, two separated bar-shaped supports located parallel to the base of the PZT mounting region, a single bar-shaped support aligned with each edge of the PZT mounting region, two separated bar-shaped supports aligned with each edge of the PZT mounting region, a circle-shaped support, a rectangle-shaped support, and/or a cross-shaped support. Also, another support may be located at a free end of each half of the PZT mounting region, alone or in addition to the other supports.

Other aspects, features, and advantages of this invention will become apparent from the following detailed description when taken in conjunction with the accompanying drawings, which are a part of this disclosure and which illustrate, by way of example, principles of this invention.

### BRIEF DESCRIPTION OF THE DRAWINGS

The accompanying drawings facilitate an understanding of the various embodiments of this invention. In such drawings:

FIG. 1 is a perspective view of a conventional disk drive unit;

FIG. 2 is a partial perspective view of the conventional disk drive unit shown in FIG. 1;

FIG. 3 is an enlarged perspective view of a conventional HGA of the disk drive from FIGS. 1 and 2;

FIG. 4 is a top view of the HGA of FIG. 3;

FIG. 5 shows a suspension tongue region deformation problem associated with a conventional HGA;

FIG. 6 shows a dimple separation problem associated with a conventional HGA;

FIG. 7a is a detailed perspective view of a HGA in accordance with an example embodiment;

FIG. 7b shows an enlarged view of an end portion of the HGA in accordance with an example embodiment;

FIG. 7c shows an enlarged view of a thin-film PZT micro-actuator in accordance with an example embodiment

FIG. 7d shows a side view of the end portion of the HGA in accordance with an example embodiment;

FIG. 8a is a detailed perspective view of the suspension flexure in tongue area in accordance with an example embodiment;

FIG. 8b is a detailed view of the suspension flexure in the tongue area viewed from the bottom in accordance with an example embodiment;

FIG. 8c is a detailed cross-sectional view of FIG. 8b taken across the A-A axis;

FIG. 9 is a detailed view of an HGA shown at least partially disassembled in accordance with an example embodiment; and,

FIGS. 10a and 10b show experimentally obtained detailed resonance testing data comparing conventional embodiments and certain example embodiments; and,

FIGS. 11a through 11e show several illustrative arrangements of metal supports in accordance with certain example embodiments.

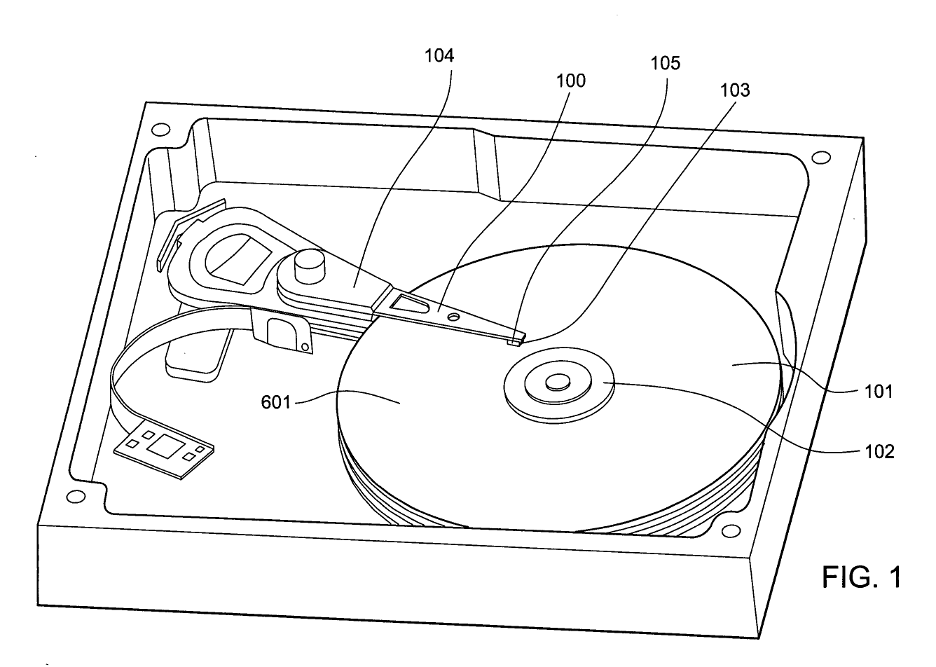

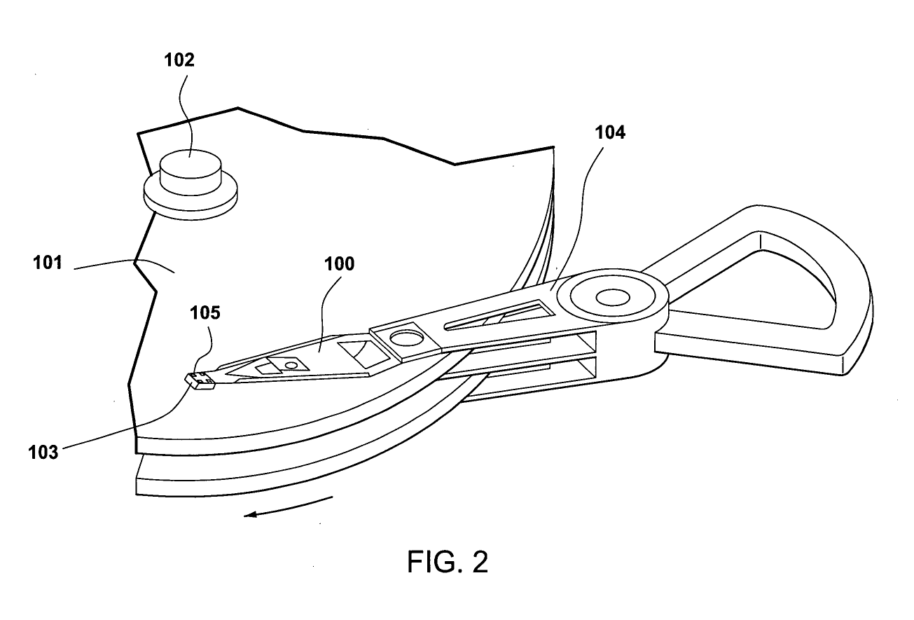

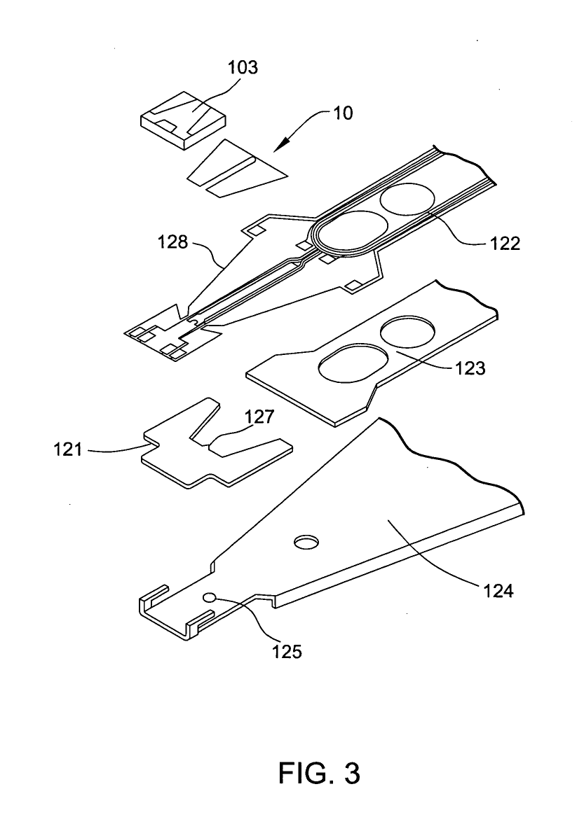

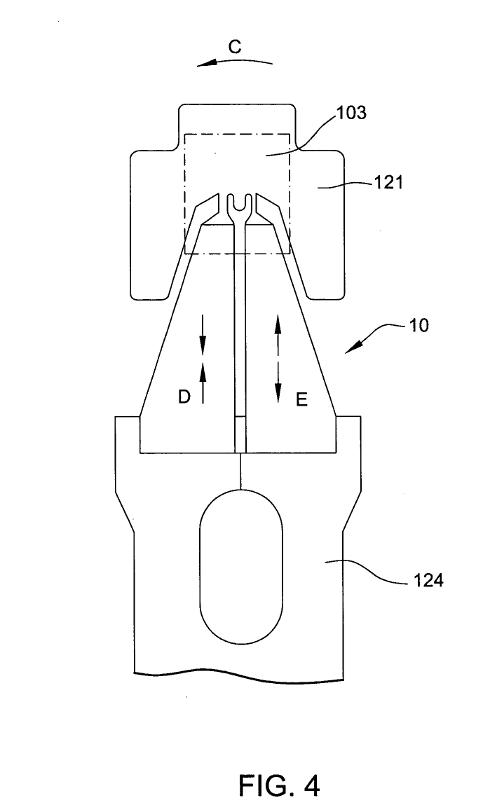

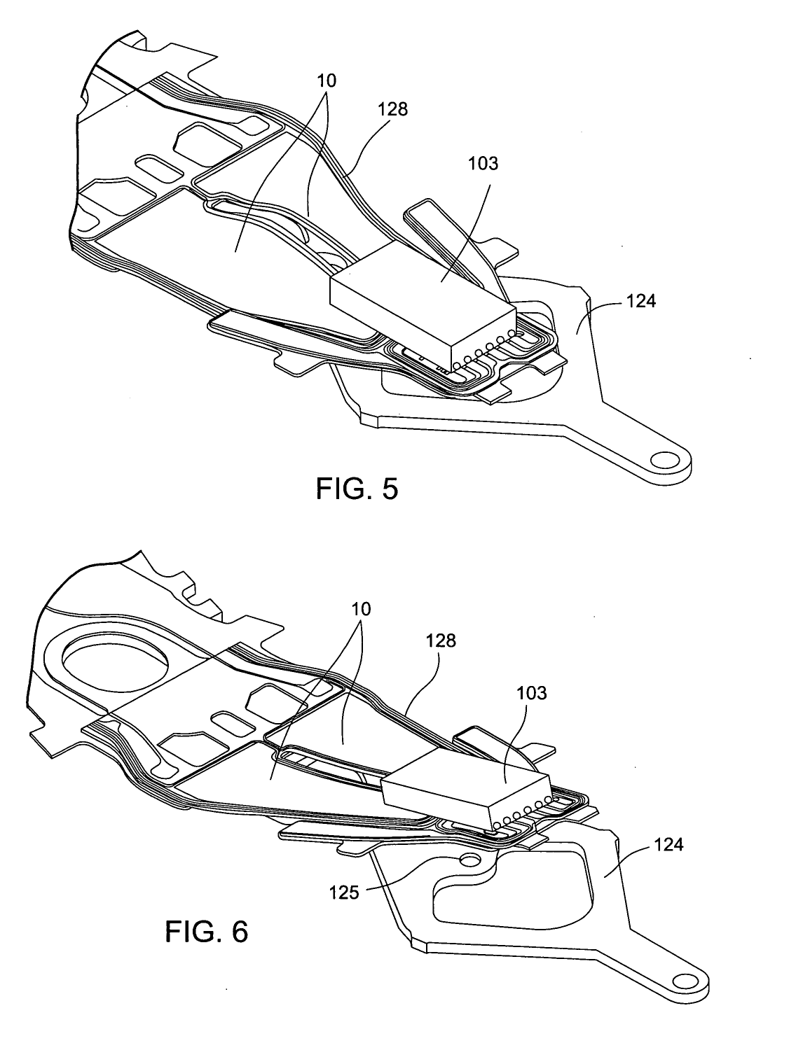

### DETAILED DESCRIPTION OF ILLUSTRATED EMBODIMENTS

Although the flexible supports are good for transferring resonances, as noted above, they may be disadvantageous because, for example, they may allow for deformation and separation problems. Conventional HGA designs include the use of polymers for soft, flexible supports for the PZT micro-actuator elements of head gimbal assemblies when fine-tuned positioning of read/write heads is desired. Thus, such designs may suffer from these disadvantages. Certain example embodiments may overcome one or more of these and/or other disadvantages by including metal support structures in the flexure, thereby reducing flexure deformation and dimple separation. Differently stated, the flexure's stiffness may be increased to reduce flexure deformation and/or dimple separation while retaining good resonance properties.

More particularly, certain example embodiments may provide metal support(s) under the tongue region of the HGA. For example, metal support(s) may be located on the back side of the flex cable under the tongue region. The resulting structure may provide a stronger support, thus potentially reducing flexure deformation and dimple separation, improving shock performance, and achieving good resonance transfer function characteristics.

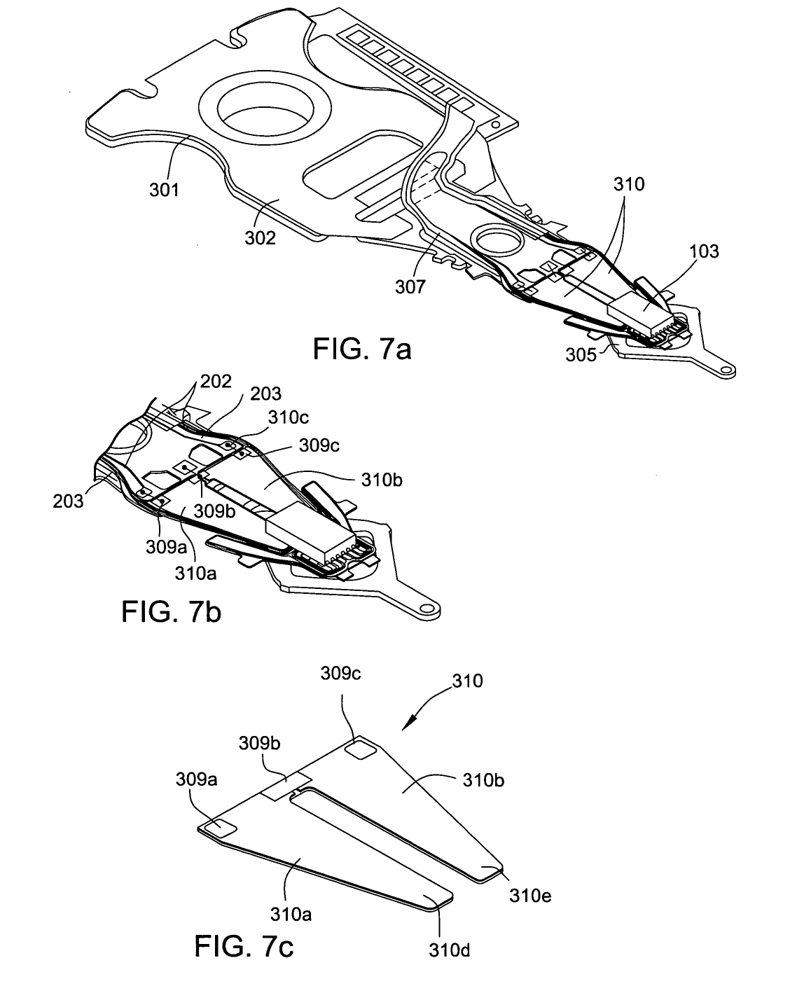

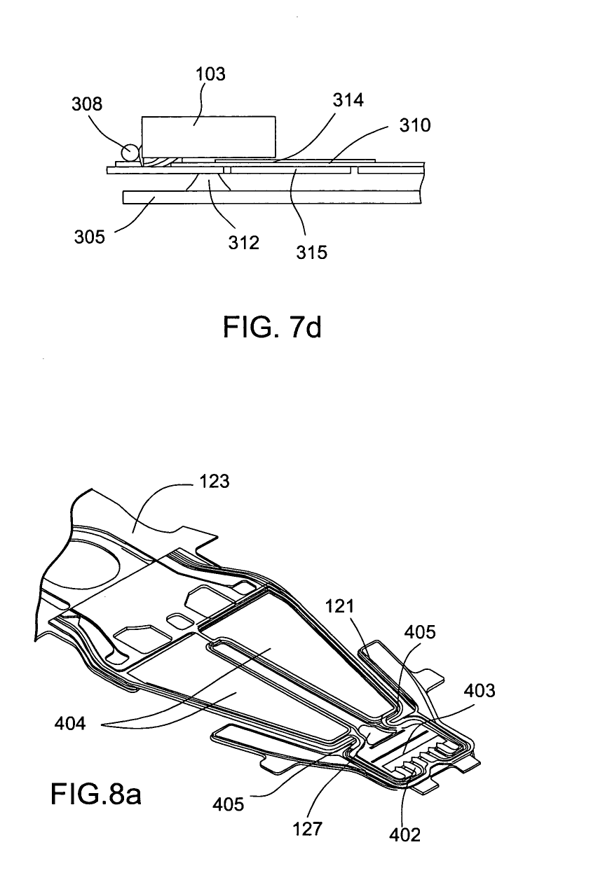

Referring now more particularly to the accompanying drawings in which like reference numerals indicate like parts throughout the several views, FIGS. 7a-7d help illustrate PZT micro-actuator elements of a HGA in accordance with certain example embodiments. FIG. 7a is a detailed perspective view of a HGA in accordance with an example embodiment. The HGA includes a load beam 305, a slider provided at the front end of the load beam, and a flexure 307 to whose front end the slider is at least partially connected. At the end of the slider are a micro-actuator 310 (described in more detail below) and a read/write head 103. The load beam 305 is fixed to a base plate 301, which includes a hinge 302.

FIG. 7b shows an enlarged view of an end portion of the HGA in accordance with an example embodiment. FIG. 7c shows an enlarged view of a thin-film PZT micro-actuator in accordance with an example embodiment. FIG. 7d shows a side view of the end portion of the HGA in accordance with an example embodiment. The thin-film micro-actuator 310 has two sides 310a-b with free ends 310d-e, respectively, and with a common coupling end 310c.

At least one bonding and/or electric pad is provided at the common end 310c. In this example embodiment, three electric pads 309a-c are provided, and pad 309b is a common ground. Wires attached to the pads may be used for electrically coupling the suspension and the thin-film PZT pieces 310a-b. The HGA also includes two electrical traces 202, 203 in the flexure. Traces 202, 203 connect with the control system (not shown) via pads 318. Trace 202 also connects to the thin-film PZT micro-actuator 310, and trace 203 also connects to the read/write head 103.

A metal support base 315 may be connected to the back side of the flexure 307 in its tongue region. The slider is partially mounted on the suspension tongue, and a parallel gap 314 exists to allow the slider to rotate freely when the PZT micro-actuator is driven. The dimple 312 in the load beam 305 supports the back side of the flexure, thus keeping the loading force applied to the center of the slider.

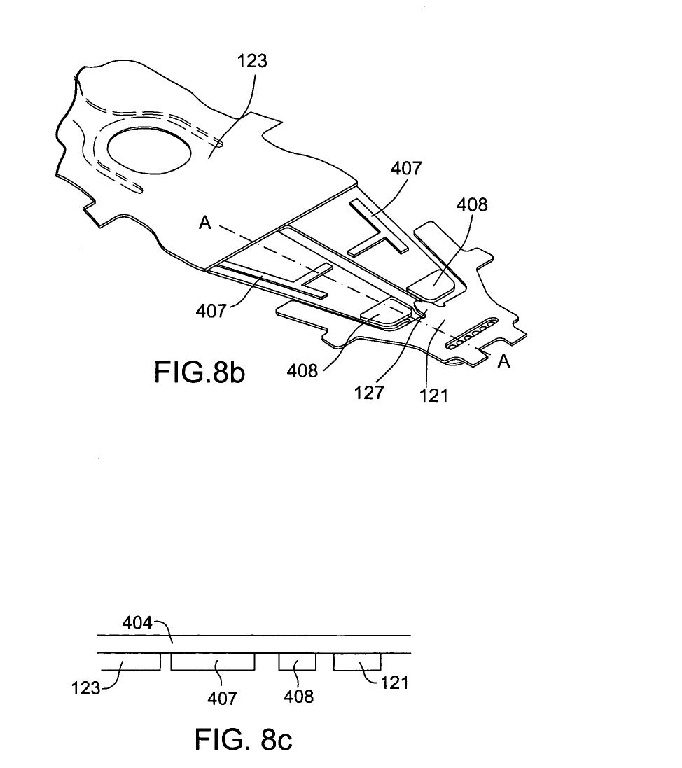

FIG. 8a is a detailed perspective view of the suspension flexure in tongue area viewed from the top in accordance with an example embodiment. The suspension flexure has a top region 403, a PZT mounting region 404, and a metal base 123 for the flexure. The top region 403 has a slider support layer part 121, and a polymer covered layer that may correspond to the PZT mounting region. Multiple traces are located on the polymer cover layer, which electrically couple the slider bonding pad(s) 402 with the suspension pads 318. The bump 127 is formed in the center portion of slider support 121, near the top region 403. Notches 405 are formed by the traces on the two opposing sides of the bump 127. This structure helps the top region 403 to easily rotate against the suspension dimple 125, which is supported by the bump 127, when the thin-film PZT micro-actuator is operated.

FIG. 8b is a detailed view of the suspension flexure in the tongue area viewed from the bottom in accordance with an example embodiment. In FIG. 8b, metal supports 407, 408 may be located on the back side of (e.g. underneath) the PZT mounting region 128 of the flexure. This support structure will stiffen the soft PZT mounting region 404, which conventionally is made from a flexible polymer material, thus reducing the deformation problems noted above, particularly during suspension manufacturing, cleaning, PZT micro-actuator attachment, HGA manufacturing, etc.

More particularly, the metal support 407 is located on the back side of (e.g. underneath) the PZT mounting region 404. This shape may be formed, for example, by chemical etching during the flexure manufacturing process, and it may be separated from the base flexure part 123 and the slider support 121. This structure may increase the stiffness of the PZT mounting region 404, thereby reducing the PZT micro-actuator deformation and/or dimple separation problems noted above. It will be appreciated that a desired stiffness may be achieved while still maintaining enough flexibility to allow the PZT micro-actuators to create finely tuned displacements.

Additionally, metal supports 408 may be formed on opposing sides of the bump 127, supporting the free ends 310d-e of the thin-film PZT micro-actuator. This will keep the PZT mounting area 404 stiff enough to avoid damage, for example, when mounting the PZT micro-actuator element to the flexure. These shapes also may be formed, for example, by chemical etching during the flexure manufacturing process.

FIG. 8c is a detailed cross-sectional view of FIG. 8b taken across the A-A axis. In particular, FIG. 8c shows the slider support 121; metal supports 407, 408; and metal flex part 123 extending downwardly (e.g. protruding) from the PZT mounting region 404. It will be appreciated that the description given with reference to FIG. 8c is by way of example only, and that the elements discussed in relation thereto may be described in other ways. For example, metal supports may be formed on PZT mounting region 404, which may, in turn, be thought of as being formed above (or even connecting) slider support 121 and metal flex part 123.

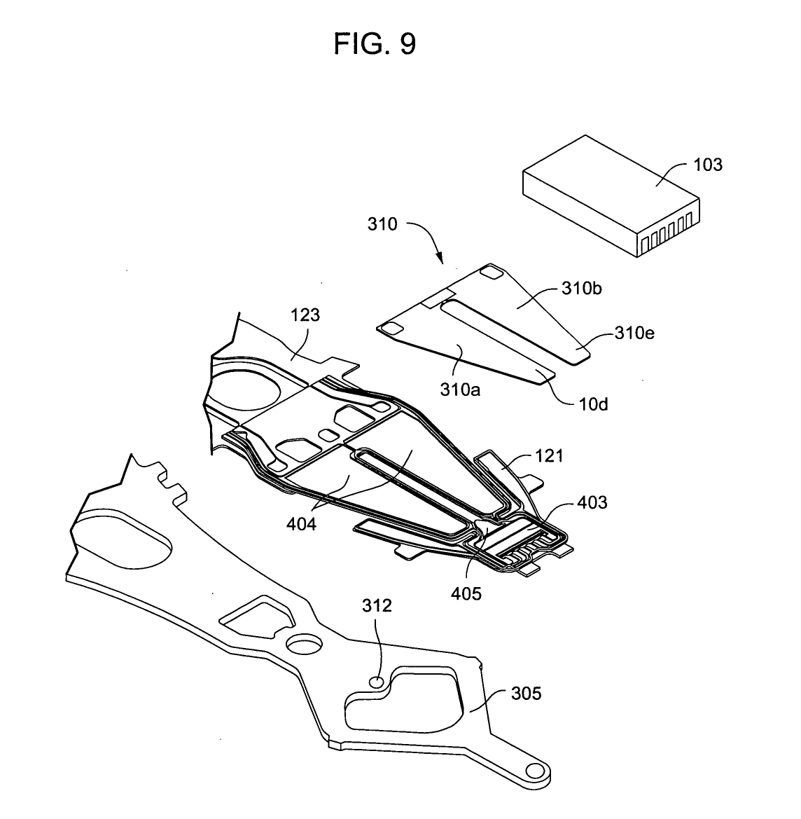

FIG. 9 is a detailed view of an HGA shown at least partially disassembled in accordance with an example embodiment. The bottom most part including the load beam 305 with the dimple 312 forms the base of the HGA. Mounted thereon are parts including the metal flex part 123 and the slider support 121 with the notch 405 formed therein, as well as the associated traces, for example, for electrically coupling various elements in the manners described above. PZT micro-actuator 310 is located in the PZT mounting region 404 as noted above. The read/write head 103 is disposed at least partially over PZT micro-actuator 310 (e.g. for fine tune control) and over top region 403.

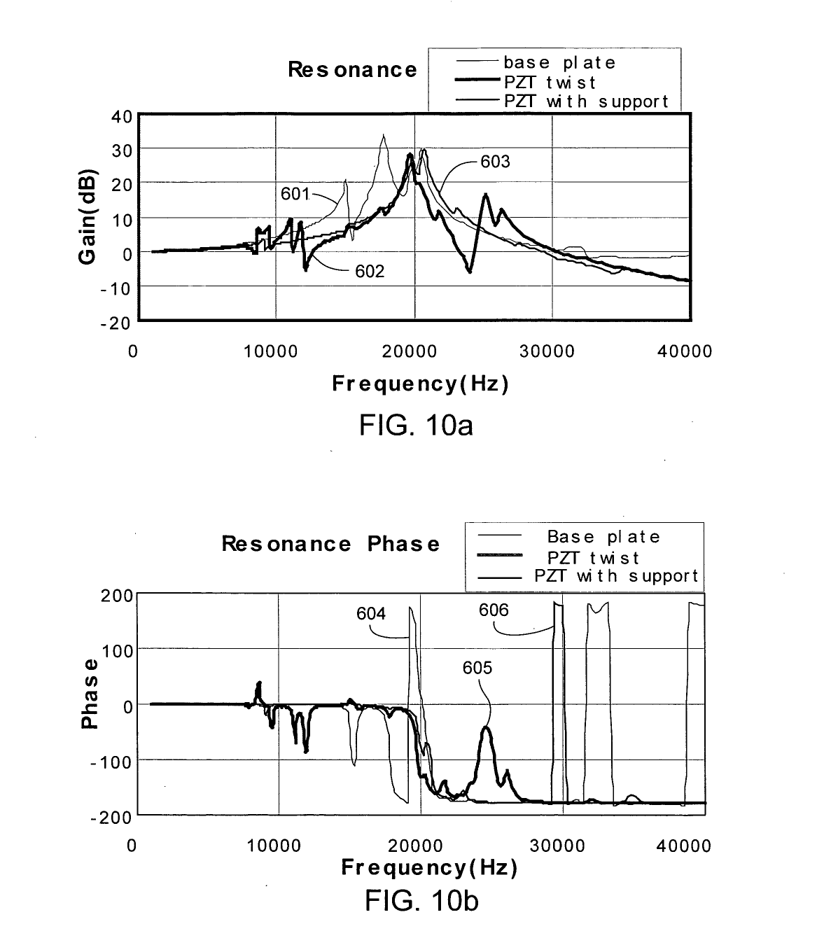

FIGS. 10a and 10b show experimentally obtained detailed resonance testing data comparing conventional embodiments and certain example embodiments. Line 601 shows suspension base plate excitation gain data, and line 604 shows its related phase. Line 602 shows excitation gain data for a PZT micro-actuator element having a twist formation, and line 605 shows its related phase. Line 603 shows excitation gain data for a PZT micro-actuator element according to an example embodiment, and line 606 shows its related phase. As shown in the graphs, PZT micro-actuators having twist formations will have several resonance peaks in the 10 Khz and 25 Khz frequency range. Those resonance peaks may have serious effects on the HGA dynamic performance, including, for example, effects on the disk drive's servo performance. Also, as will be appreciated from the graphs, certain example embodiments may be capable of improving resonances and thus allowing for good servo performance.

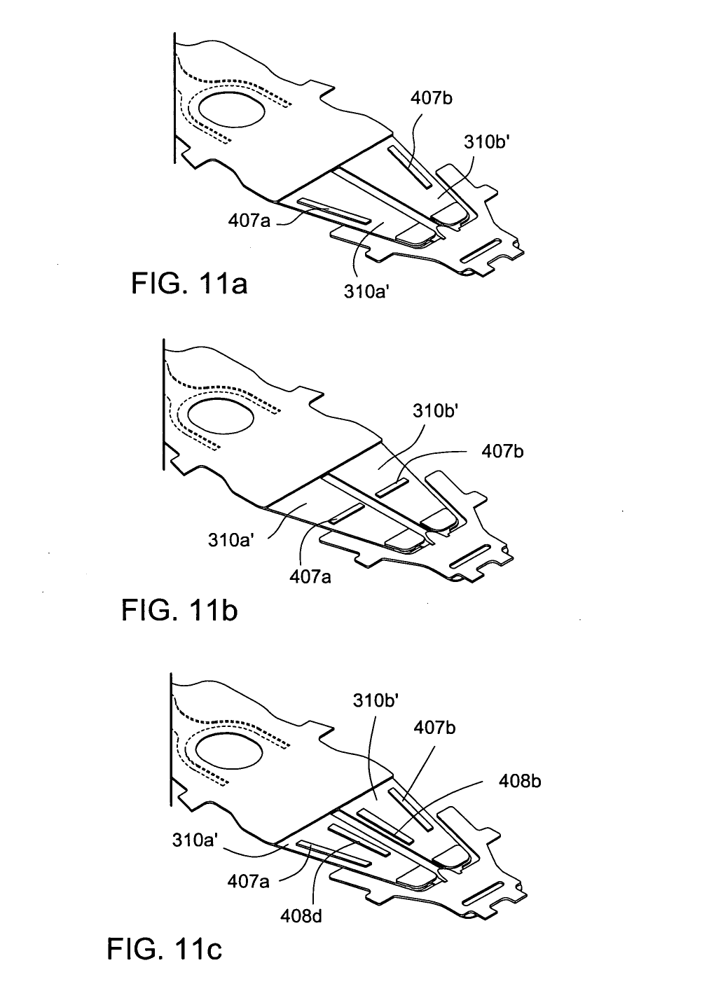

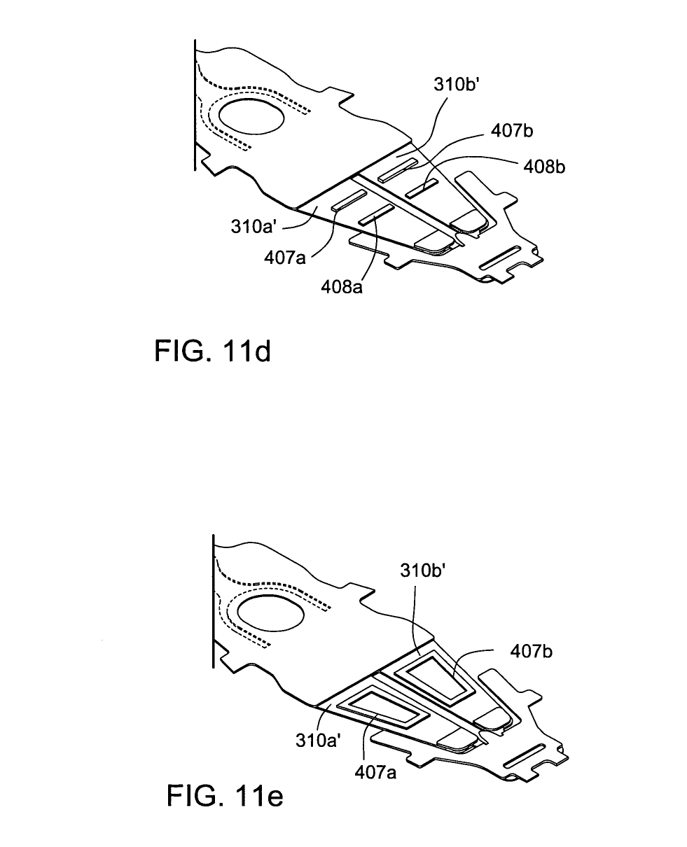

FIGS. 11a through 11e show several illustrative arrangements of metal supports in accordance with certain example embodiments. For example, on and/or underneath each half of the PZT micro-actuator 310a′-b′, the metal support may include a single bar shape, aligned with the edges of the PZT micro-actuator or parallel to the base of the PZT micro-actuator 310 (FIGS. 11a and 11b, respectively, showing support bars 407a-b). Multiple bars may be similarly disposed (FIGS. 11c and 11d, respectively, showing support bars 407a-b and 408a-b). Closed shapes also may be used, such as, for example, shapes corresponding to halves of the PZT micro-actuators, circle shapes, rectangular shapes, etc. It will be appreciated that other shapes (e.g. T-shapes, cross shapes, etc.) also may be used, alone or in combination with the shapes listed above and other shapes not listed. Additionally, one or more metal supports may located underneath the PZT mounting region 404, on top of the PZT mounting regions, etc., so long as the one or more metal supports do not interfere with the operation of the PZT micro-actuator 310.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A head gimbal assembly, comprising:
a suspension including a suspension flexure, the suspension flexure including a micro-actuator mounting region located in the suspension flexure; and,
a micro-actuator mounted to the micro-actuator mounting region of the suspension flexure;
wherein at least one support is formed on the micro-actuator mounting region, such that the support increases the stiffness of the suspension flexure.

2. The head gimbal assembly of claim 1, wherein the at least one support is a metal support.

3. The head gimbal assembly of claim 2, wherein the at least one support is formed by chemical etching.

4. The head head gimbal assembly of claim 2, wherein the PZT mounting region is divided into two halves, each half having an outside edge, and each half of the PZT mounting region including one or more of:
a single bar-shaped support located parallel to the base of the PZT mounting region, two separated bar-shaped supports located parallel to the base of the PZT mounting region, a single bar-shaped support aligned with each edge of the PZT mounting region, two separated bar-shaped supports aligned with each edge of the PZT mounting region, a circle-shaped support, a rectangle-shaped support, and/or a cross-shaped support.

5. The head gimbal assembly of claim 2, wherein the PZT mounting region is divided into two halves, each half having a free end apart from a common end, each free end including one support.

6. The head gimbal assembly of claim 4, wherein each half of the PZT mounting region has a free end apart from a common end, and further wherein each half of the PZT mounting region further includes at least one support at the free end.

7. A disk drive device, comprising:
a head gimbal assembly;
a drive arm connected to the head gimbal assembly;
a disk; and,
a spindle motor operable to spin the disk;
the head gimbal assembly including:
a suspension including a suspension flexure, the suspension flexure including a micro-actuator mounting region located in the suspension flexure; and,
a micro-actuator mounted to the micro-actuator mounting region of the suspension flexure;
wherein at least one support is formed on the micro-actuator mounting region, such that the support increases the stiffness of the suspension flexure.

8. The head gimbal assembly of claim 7, wherein the at least one support is a metal support.

9. The head gimbal assembly of claim 8, wherein the at least one support is formed by chemical etching.

10. The head head gimbal assembly of claim 8, wherein the PZT mounting region is divided into two halves, each half having an outside edge, and each half of the PZT mounting region including one or more of:
a single bar-shaped support located parallel to the base of the PZT mounting region, two separated bar-shaped supports located parallel to the base of the PZT mounting region, a single bar-shaped support aligned with each edge of the PZT mounting region, two separated bar-shaped supports aligned with each edge of the PZT mounting region, a circle-shaped support, a rectangle-shaped support, and/or a cross-shaped support.

11. The head gimbal assembly of claim 8, wherein the PZT mounting region is divided into two halves, each half having a free end apart from a common end, each free end including one support.

12. The head gimbal assembly of claim 10, wherein each half of the PZT mounting region has a free end apart from a common end, and further wherein each half of the PZT mounting region further includes at least one support at the free end.

13. A method for manufacturing a head gimbal assembly, the method comprising:
forming a slider support;
attaching PZT elements to the slider support;
preparing a flexure of a suspension;
connecting the flexure and the slider support;
forming a base plate, load beam, and hinge of the suspension;
assembling the suspension by mounting the base plate, load beam, hinge, and flexure to one another; and,
forming at least one support proximate to the PZT elements;
wherein the support is capable of increasing the stiffness of the flexure.

14. The method of claim 13, wherein the at least one support is a metal support.

15. The method of claim 14, wherein the at least one support is formed by chemical etching.

16. The method of claim 14, wherein the at least one support is one or more of:
a single bar-shaped support, two separated bar-shaped supports, a circle-shaped support, a rectangle-shaped support, and/or a cross-shaped support.
